(19) United States
(12) Patent Application Publication
(10) Pub. No.: US 2024/0036158 A1
(43) Pub. Date: Feb. 1, 2024

(54) ECHO-CANCELLING ACOUSTIC DELAY CIRCUIT AND RELATED WIRELESS DEVICE OPERABLE TO DETECT A NEARBY OBJECT

(71) Applicant: Qorvo US, Inc., Greensboro, NC (US)

(72) Inventor: Nadim Khlat, Cugnaux (FR)

(21) Appl. No.: 18/348,671

(22) Filed: Jul. 7, 2023

Related U.S. Application Data
(60) Provisional application No. 63/394,062, filed on Aug. 1, 2022.

(51) Int. Cl. G01S 7/28; H04B 1/7163; G01S 13/02; G01S 7/292

(52) U.S. Cl. CPC G01S 7/2806; H04B 1/7163; G01S 13/0209; G01S 7/2921; H04B 2201/71634

(57) ABSTRACT

An echo-cancelling acoustic delay circuit, which can be provided in a wireless device operable to detect a nearby object, is disclosed. Given the close proximity of the object, an echo of the emitted pulse(s) may be reflected instantaneously toward the antenna to potentially overlap with the emitted pulse(s), thus causing difficulty in detecting the reflected pulse(s). In this regard, the echo-cancelling acoustic delay circuit is provided in the wireless device to add a temporal delay in the emitted pulse(s) and the reflected pulse(s) to prevent the reflected pulse(s) from overlapping with the emitted pulse(s). In addition, the echo-cancelling acoustic delay circuit is further configured to cancel a reflection echo(s) in the emitted pulse(s) and the reflected pulse(s), thus allowing the wireless device to accurately receive the reflected pulse(s) to thereby detect the nearby object.

### RELATED APPLICATIONS

This application claims the benefit of U.S. provisional patent application Ser. No. 63/394,062, filed on Aug. 1, 2022, the disclosure of which is hereby incorporated herein by reference in its entirety.

### FIELD OF THE DISCLOSURE

The technology of the disclosure relates generally to an acoustic delay circuit.

### BACKGROUND

Ultra-wideband (UWB) is an Institute of Electrical and Electronic Engineers (IEEE) 802.15.4a/z standard technology optimized for secure micro-location-based applications. It is capable of measuring distance and location with extended range (e.g., up to 70 meters) and unprecedented accuracy (e.g., within a few centimeters), compared to traditional narrowband technologies such as Wi-Fi and Bluetooth. In addition to location capability, UWB can also offer a data communication pipe of 27+Mbps. As such, UWB technology has been widely adopted in today's new smartphones and smart gadgets to enable spatial awareness, object detection, and secure data collection from various sensors.

UWB based positioning service is enabled by transmitting a UWB pulse(s) from an anchor (e.g., smartphone) to an object (e.g., a UWB tag) and calculating the time it takes the UWB pulse(s) to travel between the anchor and the object. The UWB pulse(s) is typically 2 nanoseconds (ns) wide and has clean edges, thus making it highly immune to reflected signals (e.g., multipath) and allowing a precise determination of arrival time and distance in a multipath radio environment (e.g., an indoor environment).

### SUMMARY

Embodiments of the disclosure relate to an echo-cancelling acoustic delay circuit, which can be provided in a wireless device operable to detect a nearby object. Herein, an object is considered a nearby object when a roundtrip propagation duration of a pulse(s) between an antenna and the object is less than two nanoseconds (2 ns). Given the close proximity of the object, an echo of the emitted pulse(s) may be reflected instantaneously toward the antenna to potentially overlap with the emitted pulse(s), thus causing difficulty in detecting the reflected pulse(s). In this regard, the echo-cancelling acoustic delay circuit is provided in the wireless device to add a temporal delay in the emitted pulse(s) and the reflected pulse(s) to prevent the reflected pulse(s) from overlapping with the emitted pulse(s). In addition, the echo-cancelling acoustic delay circuit is further configured to cancel a reflection echo(s) in the emitted pulse(s) and the reflected pulse(s), thus allowing the wireless device to accurately receive the reflected pulse(s) to thereby detect the nearby object.

In one aspect, an echo-cancelling acoustic delay circuit is provided. The echo-cancelling acoustic delay circuit includes a first hybrid circuit. The first hybrid circuit includes a first common port, a first isolated port, a first in-phase input/output port, and a first quadrature input/output port. The echo-cancelling acoustic delay circuit also includes a second hybrid circuit. The second hybrid circuit includes a second common port, a second isolated port, a second in-phase input/output port, and a second quadrature input/output port. The echo-cancelling acoustic delay circuit also includes a first acoustic delay device. The first acoustic delay device is coupled between the first in-phase input/output port and the second in-phase input/output port. The echo-cancelling acoustic delay circuit also includes a second acoustic delay device. The second acoustic delay device is coupled between the first quadrature input/output port and the second quadrature input/output port.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part

of this specification illustrate several aspects of the disclosure, and together with the description serve to explain the principles of the disclosure.

FIG. 1 is a schematic diagram of an exemplary existing wireless device having difficulty detecting a nearby object;

FIG. 2 is a schematic diagram of an exemplary wireless device configured according to embodiments of the present disclosure to detect a nearby object based on a single antenna;

FIG. 3 is a schematic diagram of an echo-cancelling acoustic delay circuit configured according to an embodiment of the present disclosure to cancel undesired transmit (TX) and receive (RX) echoes caused inside the echo-cancelling acoustic delay circuit;

FIG. 4 is a schematic diagram of an exemplary wireless device incorporating the echo-cancelling acoustic delay circuit and configured to detect the nearby object in FIG. 2; and

FIG. 5 is a schematic diagram of an exemplary user element wherein the wireless device of FIG. 4 can be provided.

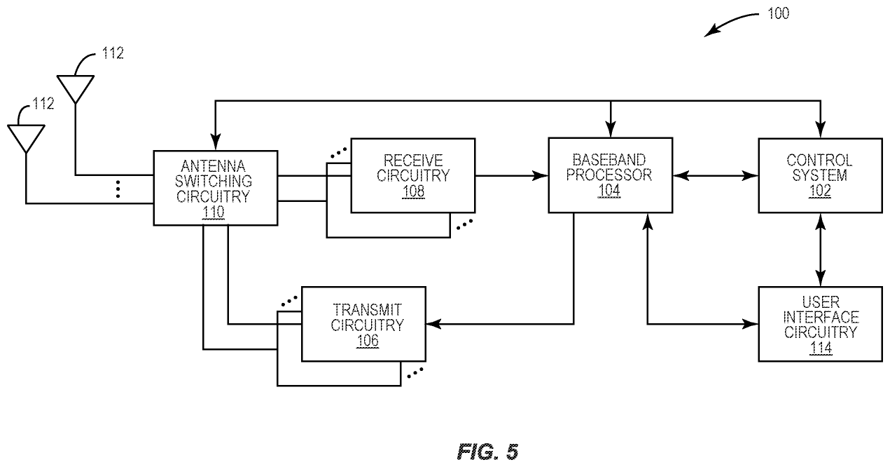

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to an echo-cancelling acoustic delay circuit, which can be provided in a wireless device operable to detect a nearby object. Herein, an object is considered a nearby object when a roundtrip propagation duration of a pulse(s) between an antenna and the object is less than two nanoseconds (2 ns). Given the close proximity of the object, an echo of the emitted pulse(s) may be reflected instantaneously toward the antenna to potentially overlap with the emitted pulse(s), thus causing difficulty in detecting the reflected pulse(s). In this regard, the echo-cancelling acoustic delay circuit is provided in the wireless device to add a temporal delay in the emitted pulse(s) and the reflected pulse(s) to prevent the reflected pulse(s) from overlapping with the emitted pulse(s). In addition, the echo-cancelling acoustic delay circuit is further configured to cancel a reflection echo(s) in the emitted pulse(s) and the reflected pulse(s), thus allowing the wireless device to accurately receive the reflected pulse(s) to thereby detect the nearby object.

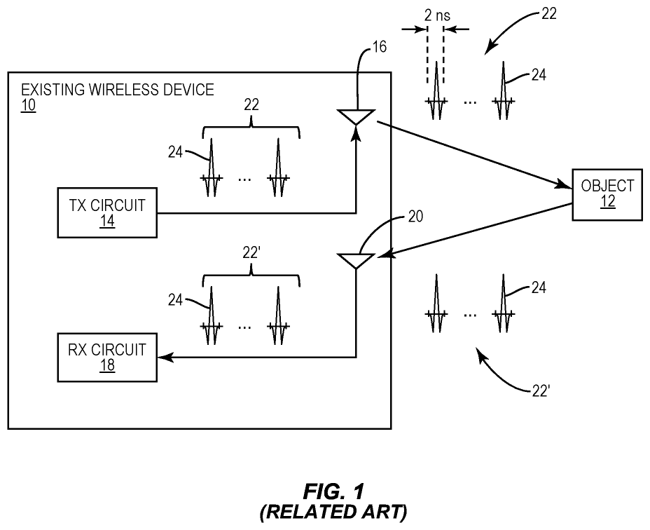

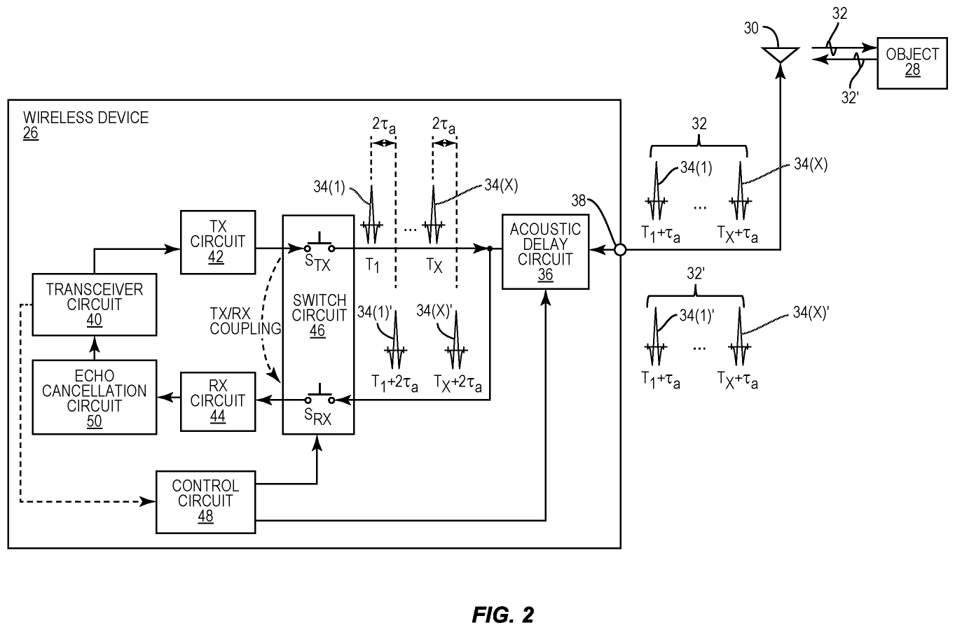

Before discussing the wireless device of the present disclosure, starting at FIG. 2, a brief overview of an existing wireless device is first discussed with reference to FIG. 1 to help understand existing challenges related to detecting a nearby object.

FIG. 1 is a schematic diagram of an exemplary existing wireless device 10 having difficulty detecting a nearby object 12. The existing wireless device 10 includes a transmitter circuit 14 coupled to a transmitting antenna 16 and a receiver circuit 18 coupled to a receiving antenna 20. To detect the object 12, the transmitter circuit 14 generates an impulse waveform 22 that includes a burst of pulses 24 and the transmitting antenna 16 emits the impulse waveform 22 toward the object 12. When the impulse waveform 22 hits the object 12, the pulses 24 are reflected by the object 12. As a result, an echo 22′ of the emitted impulse waveform (referred to as “echoed impulse waveform” for brevity) can be absorbed by the receiving antenna 20 and received by the receiver circuit 18. Accordingly, the existing wireless device 10 may detect the object 12 and determine a distance to the object 12 based on a roundtrip propagation duration of the impulse waveform 22.

In a non-limiting example, the impulse waveform 22 can be an ultra-wideband (UWB) waveform, wherein each of the pulses 24 has a pulse width of approximately two nanoseconds (2 ns). The object 12, on the other hand, may be in close proximity (e.g., 10 centimeters) to the existing wireless device 10. In this regard, the roundtrip propagation duration of the impulse waveform 22 can be as short as three-tenths of a nanosecond (0.3 ns), far shorter than the pulse width of the pulses 24. As such, the pulses 24 emitted from the transmitting antenna 16 will be echoed back toward the receiving antenna 20 almost instantaneously. Since the emitted pulses 24 typically have a higher power than the echoed pulses 24, the receiver circuit 18 may have difficulty detecting the echoed pulses 24 due to, for example, receiver saturation. As a result, the existing wireless device 10 may have difficulty detecting the nearby object 12.

Further, by employing both the transmitting antenna 16 and the receiving antenna 20, the existing wireless device 10 may need a larger footprint and be associated with a higher cost. As such, it is desirable to detect the nearby object 12 with a single antenna to help reduce footprint and cost of the existing wireless device 10.

In this regard, FIG. 2 is a schematic diagram of an exemplary wireless device 26 configured according to embodiments of the present disclosure to detect a nearby object 28 based on a single antenna 30. Similar to the existing wireless device 10 of FIG. 1, the wireless device 26 is configured to detect the nearby object 28 by emitting an impulse waveform 32, which includes a burst of pulses 34(1)-34(X), toward the nearby object 28, and detecting an echo 32′ of the emitted impulse waveform 32 (referred interchangeably as “echoed impulse waveform”), which includes echoes 34(1)′-34(X)′ of the emitted pulses 34(1)-34(X) (referred interchangeably as “echoed pulses”), reflected by the nearby object 28. In a non-limiting example, the impulse waveform 32 can be a UWB waveform generated according to an Institute of Electrical and Electronic Engineers (IEEE) 802.15.4a/z standard.

In contrast to the existing wireless device 10, the wireless device 26 includes an acoustic delay circuit 36, which is coupled to the antenna 30 via an antenna port 38. The acoustic delay circuit 36 is different from a conventional delay circuit in that the acoustic delay circuit 36 can provide a much wider bandwidth (e.g., 250 MHz) than the conventional delay circuit. As such, the acoustic delay circuit 36 can avoid distortion in the emitted impulse waveform 32 and the echoed impulse waveform 32′ across an operating bandwidth of the UWB.

According to an embodiment of the present disclosure, the acoustic delay circuit 36 is configured to add a temporal delay t₁ to each of the pulses 34(1)-34(X) before providing the pulses 34(1)-34(X) to the antenna port 38. In addition, the acoustic delay circuit 36 is also configured to add the temporal delay tₐ received via the antenna port 38 to each of the echoed pulses 34(1)′-34(X)′. By adding the temporal delay Ta in both the emitted pulses 34(1)-34(X) and the echoed pulses 34(1)′-34(X)′, it is possible to avoid overlapping between the emitted pulses 34(1)-34(X) and the echoed pulses 34(1)′-34(X)′, thus making it possible for the wireless device 26 to detect the nearby object 28. Further, by emitting the impulse waveform 32 and absorbing the echoed impulse waveform 32′ via the single antenna 30, the wireless device 26 can be smaller in footprint and cheaper in cost compared to the existing wireless device 10.

The wireless device 26 includes a transceiver circuit 40, a transmitter circuit 42, a receiver circuit 44, and a switch circuit 46. The transceiver circuit 40 may include a protocol stack (not shown) for supporting UWB physical (PHY) layer and medium access control (MAC) layer protocols. The transceiver circuit 40 can also include a baseband circuit (not shown) for generating the impulse waveform 32 according to the UWB standard and processing the echoed impulse waveform 32′ to thereby detect the nearby object 28. The transmitter circuit 42 and the receiver circuit 44 may include such active and/or passive circuits as power amplifiers, low-noise amplifiers (LNAs), transmit/receive filters, digital to analog converters (DACs), analog-to-digital converters (ADCs), and frequency converters to process the impulse waveform 32 before transmission and to process the echoed impulse waveform 32′ after reception. The switch circuit 46 may include a transmit switch STX and a receive switch SRX. In a non-limiting example, the transmit switch STX and the receive switch SRX are silicon-on-insulator (SOI) switches that can be toggled between on and off with a very short switching delay. The transmit switch STX is configured to couple (when turned on) or decouple (when turned off) the transmitter circuit 42 to or from the acoustic delay circuit 36. The receive switch SRX, on the other hand, is configured to couple (when turned on) or decouple (when turned off) the receiver circuit 44 to or from the acoustic delay circuit 36. According to an embodiment of the present disclosure, only one of the transmit switch STX and the receive switch SRX can be turned on at any given time such that the antenna 30 can be shared between the transmitter circuit 42 and the receiver circuit 44. The wireless device 26 can include a control circuit 48, such as a field-programmable gate array (FPGA), that controls the transmit switch STX and the receive switch SRX based on a time-division scheme.

To transmit the impulse waveform 32, the control circuit 48 closes the transmit switch STX and opens the receive switch SRX concurrently to couple the transmitter circuit 42 to the acoustic delay circuit 36 and decouple the receiver circuit 44 from the acoustic delay circuit 36. Accordingly, the transmitter circuit 42 can provide the pulses 34(1)-34(X) to the acoustic delay circuit 36. Herein, the pulses 34(1)-34(X) that are output from the transmitter circuit 42 are each associated with a respective one or multiple timestamps T₁-Tₓ. The acoustic delay circuit 36 adds the temporal delay tₐ to each of the pulses 34(1)-34(X) such that the pulses 34(1)-34(X) will each be associated with a respective one of multiple delayed timestamps (T₁₊ₜₐ)-(Tₓ₊ₜₐ) when the impulse waveform 32 is emitted from the antenna 30.

To receive the echoed impulse waveform 32′, the control circuit 48 closes the receive switch S_{RX} and opens the transmit switch S_{TX} concurrently to couple the receiver circuit 44 to the acoustic delay circuit 36 and decouple the transmitter circuit 42 from the acoustic delay circuit 36. Accordingly, the receiver circuit 44 can receive the echoed pulses 34(1)′-34(X)′ from the acoustic delay circuit 36. The acoustic delay circuit 36 adds the temporal delay Ta to each of the echoed pulses 34(1)′-34(X)′ such that the echoed pulses 34(1)′-34(X)′ will each be associated with a respective one of multiple delayed timestamps (T₁₊2tₐ)-(T_{X+}2tₐ) when the echoed impulse waveform 32′ is provided to the receiver circuit 44. In this regard, each of the echoed pulses 34(1)′-34(X)′ is delayed by 2tₐ from a respective one of the pulses 34(1)-34(X) that is output from the transceiver circuit 40.

Notably, it is possible that the transmit switch S_{TX} and the receive switch S_{RX} can introduce an undesired echo in the echoed impulse waveform 32′ due to, for example, TX/RX coupling. In this regard, the wireless device 26 can further include an echo cancellation circuit 50 to cancel the undesired echo in the echoed impulse waveform 32′ before providing the echoed impulse waveform 32′ to the transceiver circuit 40. In a non-limiting example, the echo cancellation circuit 50 can be pre-calibrated to store the undesired echo caused by the transmit switch S_{TX} and configured to cancel the undesired echo based on the locally stored calibration data.

In addition to the undesired echo caused by the transmit switch S_{TX} and the receive switch S_{RX}, the acoustic delay circuit 36 may also introduce the undesired echo in the impulse waveform 32 and/or the echoed impulse waveform 32′. As such, it is desirable to further cancel the undesired echo caused by the acoustic delay circuit 36.

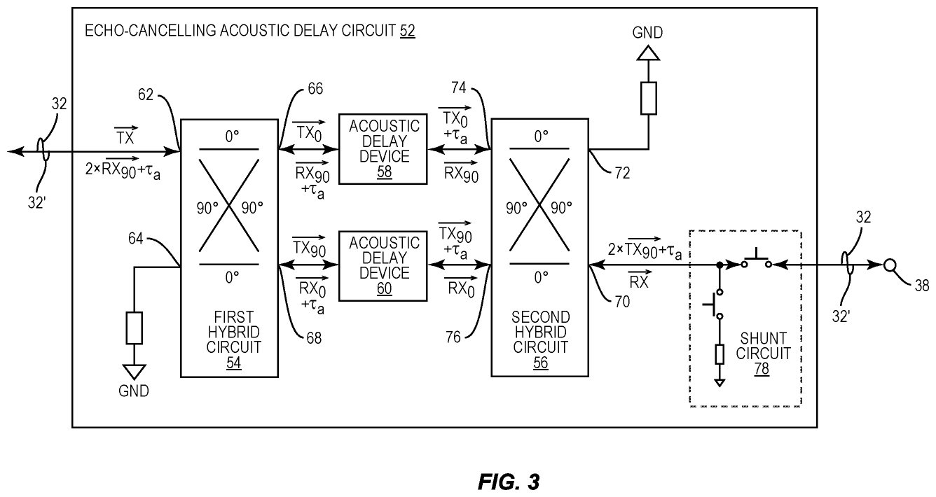

In this regard, FIG. 3 is a schematic diagram of an echo-cancelling acoustic delay circuit 52 configured to cancel undesired transmit (TX) and receive (RX) echoes caused inside the echo-cancelling acoustic delay circuit 52. Common elements between FIGS. 2 and 3 are shown therein with common element numbers and will not be re-described herein.

In an embodiment, the echo-cancelling acoustic delay circuit 52 includes a first hybrid circuit 54, a second hybrid circuit 56, a first acoustic delay device 58, and a second acoustic delay device 60. In a non-limiting example, the first acoustic delay device 58 and the second acoustic delay device 60 can be bulk acoustic wave (BAW) devices. For exemplary implementations of the first acoustic delay device 58 and the second acoustic delay device 60, please refer to U.S. Provisional Patent Application No. 63/390,681, entitled “WIRELESS DEVICE OPERABLE TO DETECT A NEARBY OBJECT.” The first hybrid circuit 54 includes a first common port 62, a first isolated port 64, a first in-phase input/output port 66, and a first quadrature input/output port 68. The second hybrid circuit 56 includes a second common port 70, a second isolated port 72, a second in-phase input/output port 74, and a second quadrature input/output port 76.

Herein, the first common port 62 is coupled to the switch circuit 46 in FIG. 2 and the second common port 70 is coupled to the antenna port 38 in FIG. 2. The first isolated port 64 and the second isolated port 72 are both coupled to a ground (GND). The first acoustic delay device 58 is coupled between the first in-phase input/output port 66 and the second in-phase input/output port 74. The second acoustic delay device 60 is coupled between the first quadrature input/output port 68 and the second quadrature input/output port 76.

The first hybrid circuit 54 is configured to receive a transmit signal [symbol] via the first common port 62. In an embodiment, the transmit signal [symbol] can be identical to or include the impulse waveform 32. Herein, the first hybrid circuit 54 is configured to convert the transmit signal [symbol] into an in-phase transmit signal [symbol] and a quadrature transmit signal [symbol] each having one-half (½) the power of the transmit signal [symbol] The first acoustic delay device 58 adds the temporal delay tₐ in the in-phase transmit signal [symbol] to generate a delayed in-phase transmit signal [symbol] . Likewise, the second acoustic delay device 60 adds the temporal delay tₐ in the quadrature transmit signal [symbol] to generate a delayed quadrature transmit signal [symbol] Note that the first acoustic delay device 58 and the second acoustic delay device 60 may cause the undesired TX echo in the transmit signal [symbol] As such, the first hybrid circuit 54 is further configured to cancel the undesired TX echo in the transmit signal [symbol] by shunting the undesired TX echo to the GND via the first isolated port 64. The second hybrid circuit 56 is configured to regenerate a delayed transmit signal [symbol] from the delayed in-phase transmit signal [symbol] and the delayed quadrature transmit signal

[symbol]

The second hybrid circuit 56 is configured to receive a receive signal [symbol] via the second common port 70. In an embodiment, the receive signal [symbol] can be identical to or include the echoed impulse waveform 32′. Herein, the second hybrid circuit 56 is configured to convert the receive signal [symbol] into an in-phase receive signal [symbol] and a quadrature receive signal [symbol] each having one-half (½) the power of the receive signal [symbol] The first acoustic delay device 58 adds the temporal delay tₐ in the in-phase receive signal [symbol] to generate a delayed in-phase receive signal [symbol] Likewise, the second acoustic delay device 60 adds the temporal delay Ta in the quadrature receive signal [symbol] to generate a delayed quadrature receive signal [symbol] Note that the first acoustic delay device 58 and the second acoustic delay device 60 may cause the undesired RX echo in the receive signal [symbol] As such, the second hybrid circuit 56 is further configured to cancel the undesired RX echo in the receive signal [symbol] by shunting the undesired RX echo to the GND via the second isolated port 72. The first hybrid circuit 54 is configured to regenerate a delayed receive signal [symbol] from the delayed in-phase receive signal [symbol] and the delayed quadrature receive signal

[symbol]

The echo-cancelling acoustic delay circuit 52 may also include a shunt circuit 78, which can be an acoustic shunt circuit, as an example. In a non-limiting example, the shunt circuit 78 can help pre-calibration of the echo cancellation circuit 50 and/or elimination of the undesired echo introduced by the transmit switch STX.

With reference back to FIG. 2, in an embodiment, the acoustic delay circuit 36 can be replaced by the echo-cancelling acoustic delay circuit 52 of FIG. 3. Like the acoustic delay circuit 36, the echo-cancelling acoustic delay circuit 52 can also add the temporal delay tₐ to each of the pulses 34(1)-34(X) and add the temporal delay Ta to each of the echoed pulses 34(1)′-34(X)′. In addition, the echo-cancelling acoustic delay circuit 52 can cancel undesired TX and RX echoes caused by the first acoustic delay device 58 and the second acoustic delay device 60 to thereby help the wireless device 26 to accurately detect the nearby object 28.

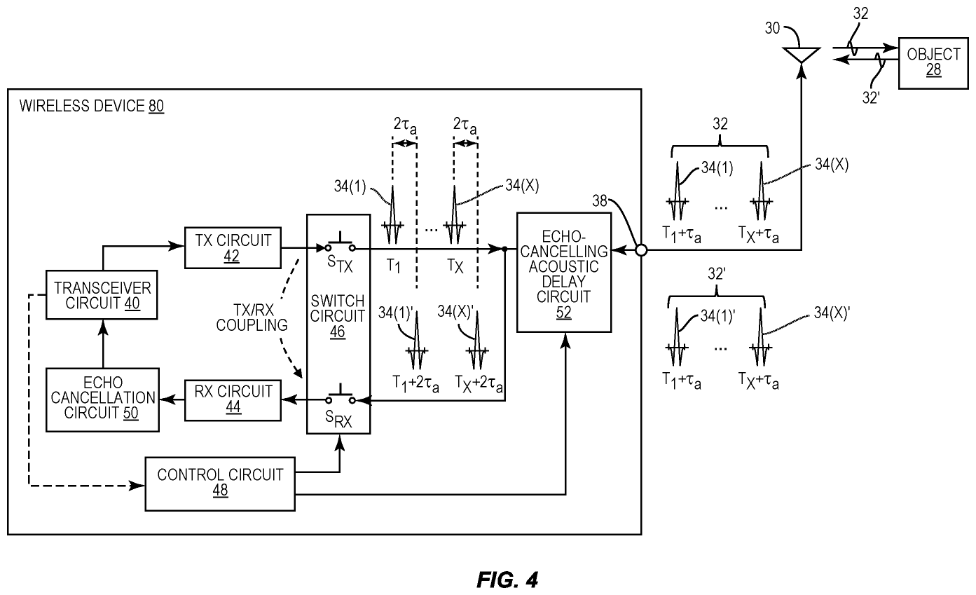

In this regard, FIG. 4 is a schematic diagram of an exemplary wireless device 80 incorporating the echo-cancelling acoustic delay circuit 52 of FIG. 3 and configured to detect the nearby object 28 of FIG. 2. Common elements between FIGS. 2, 3, and 4 are shown therein with common element numbers and will not be re-described herein. Notably, the echo-cancelling acoustic delay circuit 52 inherits all functionalities of the acoustic delay circuit 36 in FIG. 2. In addition, the echo-cancelling acoustic delay circuit 52 is further configured to cancel undesired TX and receive RX echoes.

The wireless device 80 of FIG. 4 can be provided in a user element to enable bandwidth adaptation according to embodiments described above. In this regard, FIG. 4 is a schematic diagram of an exemplary user element 100 wherein the wireless device 80 of FIG. 4 can be provided.

Herein, the user element 100 can be any type of user elements, such as mobile terminals, smart watches, tablets, computers, navigation devices, access points, and like wireless communication devices that support wireless communications, such as cellular, wireless local area network (WLAN), Bluetooth, and near field communications. The user element 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

Those skilled in the art will recognize improvements and modifications to the preferred embodiments of the present disclosure. All such improvements and modifications are considered within the scope of the concepts disclosed herein and the claims that follow.

What is claimed is:

1. An echo-cancelling acoustic delay circuit comprising:
a first hybrid circuit comprising a first common port, a first isolated port, a first in-phase input/output port, and a first quadrature input/output port;
a second hybrid circuit comprising a second common port, a second isolated port, a second in-phase input/output port, and a second quadrature input/output port;
a first acoustic delay device coupled between the first in-phase input/output port and the second in-phase input/output port; and
a second acoustic delay device coupled between the first quadrature input/output port and the second quadrature input/output port.

2. The echo-cancelling acoustic delay circuit of claim 1, wherein:
the first common port is coupled to a transmitter circuit and a receiver circuit, and the first hybrid circuit is configured to:
receive a transmit signal from the transmitter circuit via the first common port; and
provide a receive signal to the receiver circuit via the first common port; and
the second common port is coupled to an antenna port, and the second hybrid circuit is configured to:
provide the transmit signal to the antenna port; and
receive the receive signal from the antenna port.

3. The echo-cancelling acoustic delay circuit of claim 2, wherein:
the transmit signal comprises an impulse waveform to be emitted via the antenna port; and
the receive signal comprises a reflection of the emitted impulse waveform received via the antenna port.

4. The echo-cancelling acoustic delay circuit of claim 2, wherein:
the first hybrid circuit is further configured to split the transmit signal into an in-phase transmit signal and a quadrature transmit signal;
the first acoustic delay device is configured to delay the in-phase transmit signal by a temporal delay;
the second acoustic delay device is configured to delay the quadrature transmit signal by the temporal delay; and
the second hybrid circuit is further configured to regenerate the transmit signal from the in-phase transmit signal and the quadrature transmit signal.

5. The echo-cancelling acoustic delay circuit of claim 4, wherein the first hybrid circuit is further configured to cancel a transmit (TX) echo caused by the first acoustic delay device and the second acoustic delay device in the transmit signal.

6. The echo-cancelling acoustic delay circuit of claim 5, wherein the first hybrid circuit is further configured to cancel the TX echo via the first isolated port.

7. The echo-cancelling acoustic delay circuit of claim 2, wherein:
the second hybrid circuit is further configured to split the receive signal into an in-phase receive signal and a quadrature receive signal;
the first acoustic delay device is configured to delay the in-phase receive signal by a temporal delay;
the second acoustic delay device is configured to delay the quadrature receive signal by the temporal delay; and
the second hybrid circuit is further configured to regenerate the receive signal from the in-phase receive signal and the quadrature receive signal.

8. The echo-cancelling acoustic delay circuit of claim 7, wherein the second hybrid circuit is further configured to cancel a receive (RX) echo caused by the first acoustic delay device and the second acoustic delay device in the receive signal.

9. The echo-cancelling acoustic delay circuit of claim 8, wherein the second hybrid circuit is further configured to cancel the RX echo via the second isolated port.

10. The echo-cancelling acoustic delay circuit of claim 2, further comprising a shunt circuit coupled between the second common port and the antenna port.

11. A wireless device comprising:
a transmitter circuit configured to generate an impulse waveform;
an antenna port coupled to an antenna configured to emit the impulse waveform toward a nearby object and absorb an echo of the emitted impulse waveform reflected by the nearby object;
a receiver circuit configured to receive the echo of the emitted impulse waveform; and
an echo-cancelling acoustic delay circuit configured to:
receive the impulse waveform from the transmitter circuit;
delay the impulse waveform by a temporal delay;
provide the delayed impulse waveform to the antenna port;
receive the echo of the emitted impulse waveform from the antenna port;
delay the echo of the emitted impulse waveform by the temporal delay; and
provide the delayed echo of the emitted impulse waveform to the receiver circuit.

12. The wireless device of claim 11, wherein the impulse waveform is an ultra-wideband (UWB) waveform.

13. The wireless device of claim 11, wherein the echo-cancelling acoustic delay circuit comprises:
a first hybrid circuit comprising a first common port, a first isolated port, a first in-phase input/output port, and a first quadrature input/output port;
a second hybrid circuit comprising a second common port, a second isolated port, a second in-phase input/output port, and a second quadrature input/output port;
a first acoustic delay device coupled between the first in-phase input/output port and the second in-phase input/output port; and
a second acoustic delay device coupled between the first quadrature input/output port and the second quadrature input/output port.

14. The wireless device of claim 13, wherein:
the first common port is coupled to the transmitter circuit and the receiver circuit, and the first hybrid circuit is configured to:
receive a transmit signal comprising the impulse waveform from the transmitter circuit via the first common port; and
provide a receive signal comprising the echo of the emitted impulse waveform to the receiver circuit via the first common port; and
the second common port is coupled to the antenna port, and the second hybrid circuit is configured to:
provide the transmit signal to the antenna port; and
receive the receive signal from the antenna port.

15. The wireless device of claim 14, wherein:
the first hybrid circuit is further configured to split the transmit signal into an in-phase transmit signal and a quadrature transmit signal;
the first acoustic delay device is configured to delay the in-phase transmit signal by the temporal delay;
the second acoustic delay device is configured to delay the quadrature transmit signal by the temporal delay; and
the second hybrid circuit is further configured to regenerate the transmit signal from the in-phase transmit signal and the quadrature transmit signal.

16. The wireless device of claim 15, wherein the first hybrid circuit is further configured to cancel a transmit (TX) echo caused by the first acoustic delay device and the second acoustic delay device in the transmit signal.

17. The wireless device of claim 16, wherein the first hybrid circuit is further configured to cancel the TX echo via the first isolated port.

18. The wireless device of claim 14, wherein:
the second hybrid circuit is further configured to split the receive signal into an in-phase receive signal and a quadrature receive signal;
the first acoustic delay device is configured to delay the in-phase receive signal by the temporal delay;
the second acoustic delay device is configured to delay the quadrature receive signal by the temporal delay; and
the second hybrid circuit is further configured to regenerate the receive signal from the in-phase receive signal and the quadrature receive signal.

19. The wireless device of claim 18, wherein the second hybrid circuit is further configured to cancel a receive (RX) echo caused by the first acoustic delay device and the second acoustic delay device in the receive signal.

20. The wireless device of claim 19, wherein the second hybrid circuit is further configured to cancel the RX echo via the second isolated port.
